(19) United States
(12) Patent Application Publication
(10) Pub. No.: US 2015/0108702 A1
(43) Pub. Date: Apr. 23, 2015

(54) Aggregate Connecting Cutting/Serving Board with Glass Holder

(71) Applicants: Tang Heng Quanh, Woodbridge (CA); Mario Christian Lavorato, Toronto (CA)

(72) Inventors: Tang Heng Quanh, Woodbridge (CA); Mario Christian Lavorato, Toronto (CA)

(21) Appl. No.: 14/056,510

(22) Filed: Oct. 17, 2013

(51) Int. Cl. A47J 47/00; A47G 23/06

(52) U.S. Cl. CPC A47J 47/005; A47G 23/06
USPC 269/289 R

(57) ABSTRACT

One embodiment of aggregate connecting cutting/serving board with glass holder (14) includes a generally planar cutting surface (16) that can rest on a countertop to enable cutting. In addition, the board is shaped like a jig-saw puzzle to allow more than two boards to connect to one another (10,14). One portion of the board is adapted to hold glasses (14) and able to rest on the countertop with the glass in place (18). In some versions, the boards are in various geometric shapes and sizes.

### CROSS-REFERENCE TO RELATED APPLICATIONS

N/A

### BACKGROUND

### Prior Art

The following is a tabulation of some prior art that presently appears relevant:

U.S. Patents

| Patent Number | Kind Code | Issue Date | Patentee |
|---|---|---|---|
| 8,360,407 | B2 | 2013 Jan. 29 | Kent |
| 573,419 | S | 2008 Jul. 22 | Kaposi |
| 5,593,062 | A | 1997 Jul. 14 | Martin |
| 5,203,548 | B1 | 1993 Apr. 20 | Sanders |
| 251,471 | S1 | 1979 Apr. 03 | Lutzker |
| 251,534 | S1 | 1979 Apr. 10 | Lutzker |
| 3,708,086 | A | 1973 Jan. 02 | Colato |

U.S. Patent Application Publications

| Publication Nr. | Kind Code | Publ. Date | Applicant |
|---|---|---|---|
| 20070001359 | A1 | 2007 Jan. 04 | Pearl et al. |

Traditional cutting boards and serving boards have long been used in the kitchen and in the dining room to prepare food, serve food and be used as a surface for display. In the Food industry it is often useful to have a surface that can both be used for preparation as well as serving. Rarely has the design and utility of this household staple been modified and re-conceived giving most boards an aesthetic of myopic utilitarianism.

### SUMMARY

In accordance with one embodiment an aggregate connecting cutting/serving board comprises a tab/handle, a blank/holder, indentations for base of glass, and cavities that fits together and double as glass holders.

### ADVANTAGES

The idea of an aggregate design for the purpose of offering large-small, unique and customizable cutting space is the driving force behind the design of this invention. The need for customizable space and serving area is a paramount issue in both the kitchen and at the serving table. Further, tradition cutting surfaces do not offer a level of functionality which allows them to double as both preparation surface and serving surface. This invention can be used as aggregate pieces that fit together to create a cutting board or used separately as dining trays that double as wine glass holders. The invention allows for infinite possibilities in the kitchen or at the dinner party. It can be used alone for a small cutting space or fit them together for when a larger surface is necessary. The invention is for dinner parties as they allow the guests to enjoy both wine and Hors d'oeuvre leaving one hand free.

This invention not only offers the user an aggregate serving/preparation surface it also doubles as a bowl, stern & foot glass holder for convenience. Indents in the right hand surface allow for separated items to be plated upon serving and the curvature of the negative space on one side of each board allows for the user to hold any drinking vessel design with a bowl and stem, at various angles. The beveling of the millwork under the negative space is designed to allow both the serving board and the foot of a glass, not limited to wine glasses, to sit unencumbered while resting flat on any surface. Typical Serving surfaces do not offer designs that let both food and wine be held with ease, creating awkward and often uncomfortable situations where no hands are free while eating and drinking at a catered event.

### DRAWINGS—FIGURES

The preferred versions of the invention are described below and illustrated in the following figures.

FIG. 1 shows the perspective view of the invention with the glass in the holder

FIG. 1A shows the contour lines of the form to illustrate the full extent of the invention

FIG. 2 shows the top perspective view of the invention

FIG. 3 shows the bottom perspective view of the invention with the indentation for the base of glasses

FIG. 4 shows the top perspective view of the invention with the glass sitting unencumbered

FIG. 5 shows the bottom perspective view of the invention

FIG. 6 shows the top perspective view of the invention

FIG. 7 shows the perspective view of the invention

FIG. 8 shows the top plan view of the invention

FIG. 9 shows the cross-sectional view of the invention

FIG. 10 shows the cross-sectional view of the invention

FIG. 11 shows the side elevation view of the invention

FIG. 12 shows the side elevation view of the invention

FIG. 13 shows the top plan view of the invention

FIG. 14 shows the bottom plan view of the invention

FIG. 15 shows the south side elevation view of the invention

FIG. 16 shows the left side elevation view of the invention

FIG. 17 shows the right side elevation view of the invention

FIG. 18 shows the north side elevation view of the invention

FIG. 19 shows the top plan view of the interconnecting rectangular embodiment of the invention

FIG. 20 shows the perspective view of the interconnecting rectangular embodiment of the invention

FIG. 21 shows the perspective view of the square embodiment of the invention

FIG. 22 shows the top plan view of the square embodiment of the invention

FIG. 23 shows the perspective view of the triangle embodiment of the invention

FIG. 24 shows the top plan view of the triangle embodiment of the invention

FIG. 25 shows the perspective view of the curved embodiment of the invention

FIG. 26 shows the top plan view of the curved embodiment of the invention

FIG. 27 shows the top plan view of the interconnecting rectangle pieces

FIG. 28 shows the top plan view of the interconnecting square pieces

FIG. 29 shows the top plan view of the interconnecting triangle pieces

FIG. 30 shows the top plan view of the interconnecting curved pieces

Drawings- Reference Numerals

| | |
|---|---|
| 10 tab/handle | 12 cavities |
| 14 blank/holder | 16 upper surface of board |
| 18 indent for base of glass | 20 bottom surface of board |
| 22 glass | |

### DETAILED DESCRIPTION OF THE PREFERRED EMBODIMENT

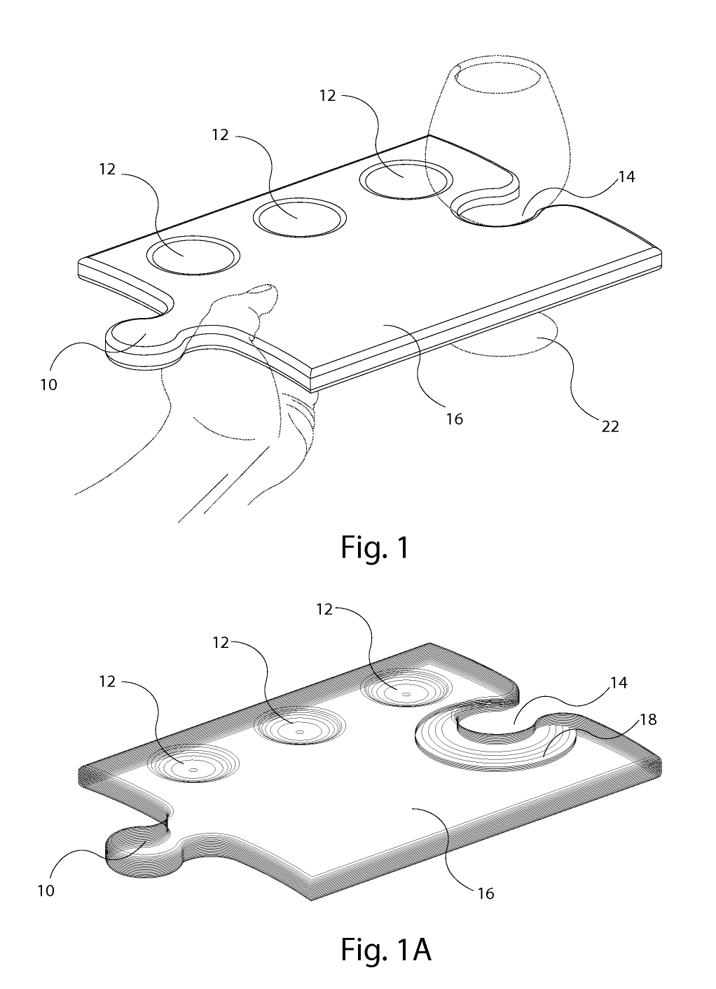

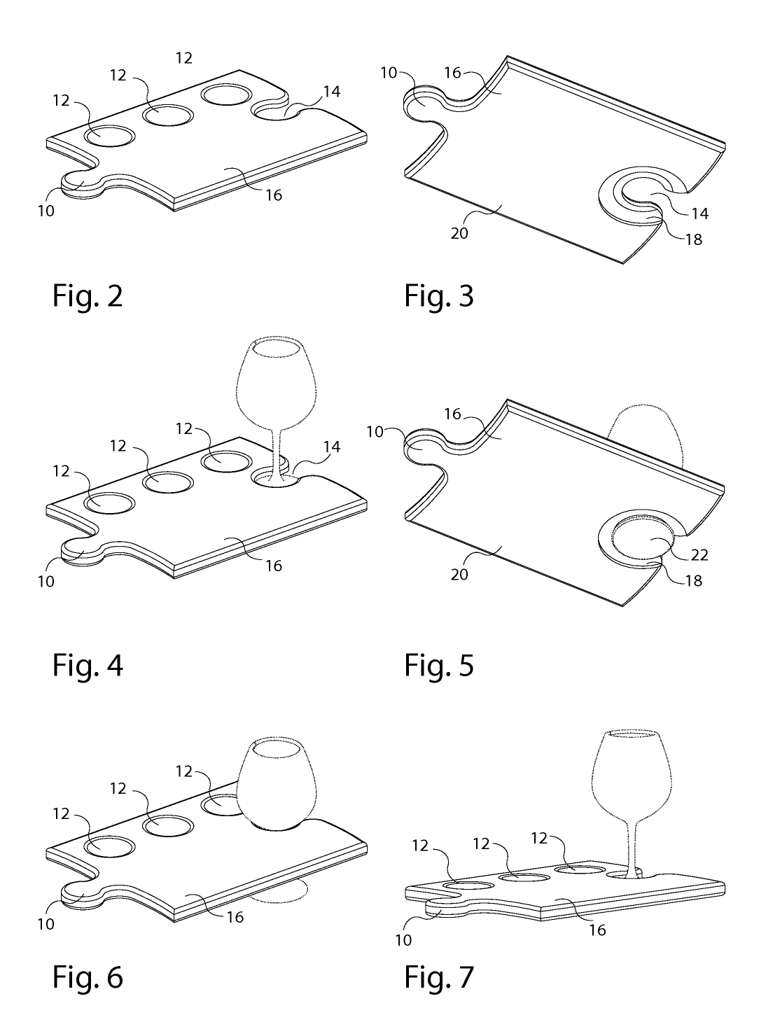

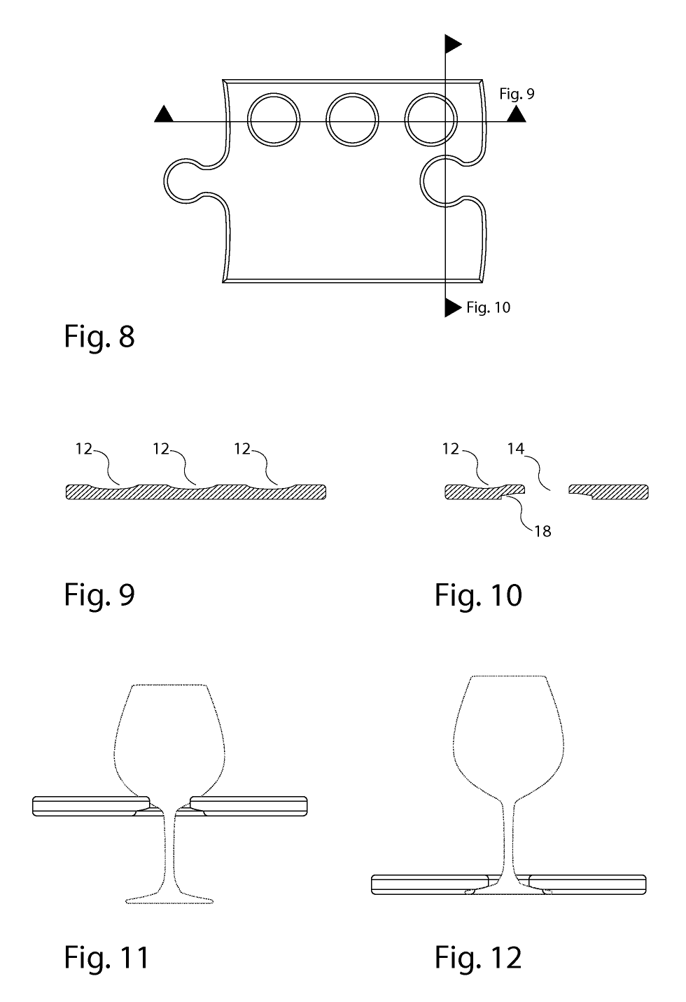

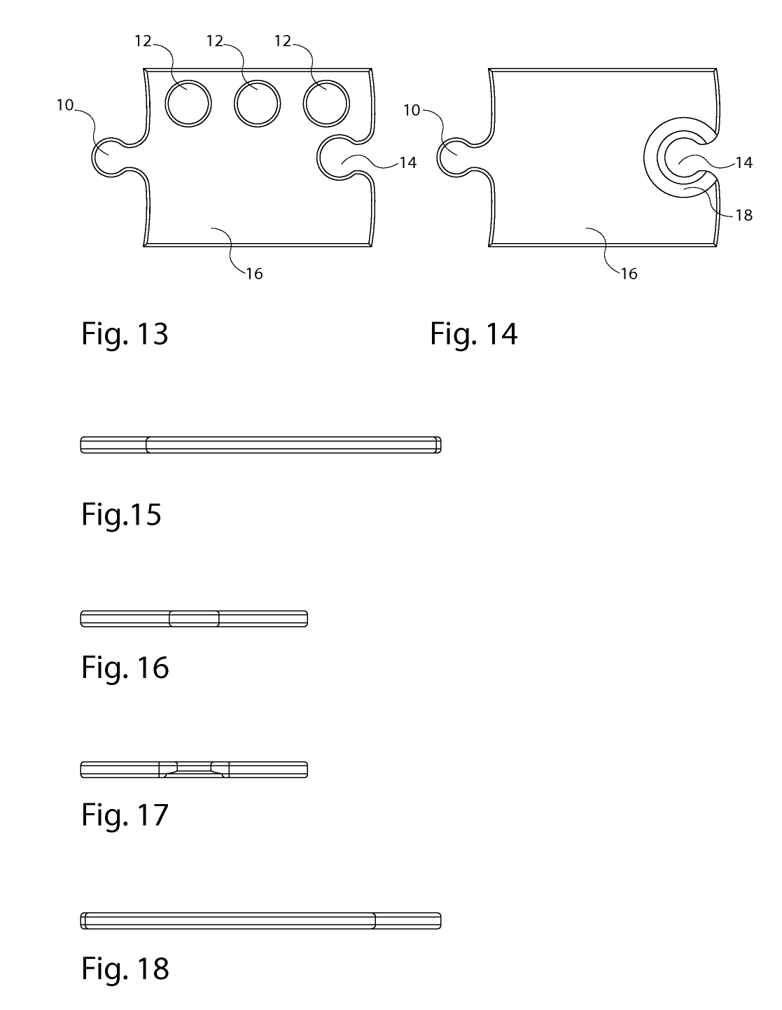

With reference to FIGS. 1-20, the exemplary aggregate connecting cutting/serving board includes a planar cutting surface 16, 20. The substantially planar cutting surface is configured to rest on a countertop to provide a surface suitable for cutting foods. The cutting board may be formed from any suitable materials, for example, wood or plastics such as polyethylene. The upper surface 16 of the cutting/serving board should be relatively smooth and planar, while the lower surface 20 should be configured to rest on a horizontal surface such as a countertop. The lower surface 20 may optionally include a layer of resilient material such as a thermoplastic elastomer, or feet made from such a material, to prevent the cutting board from sliding on the countertop.

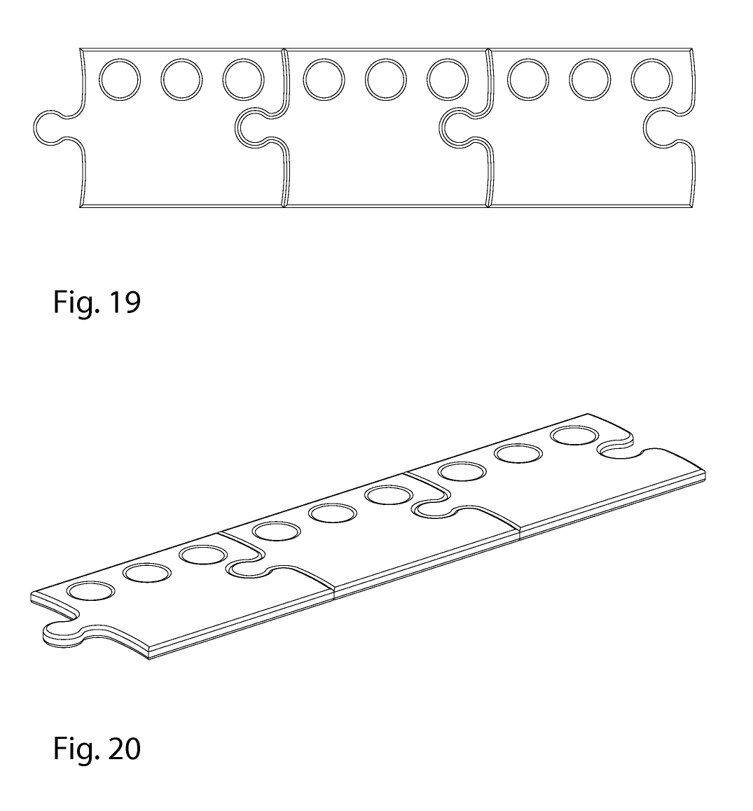

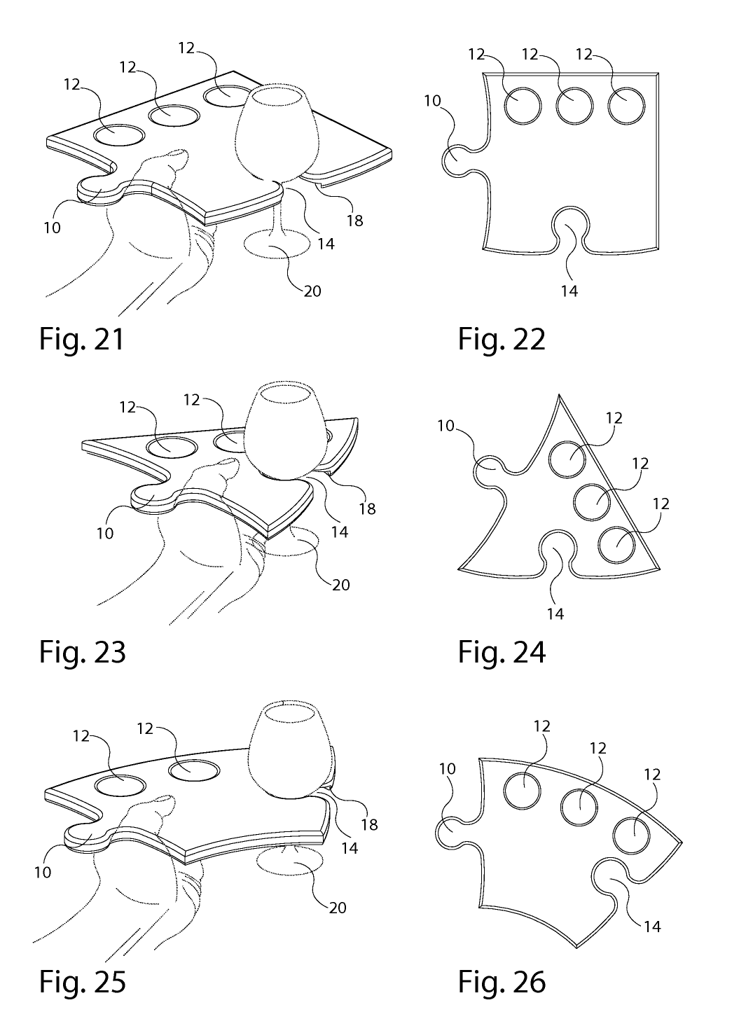

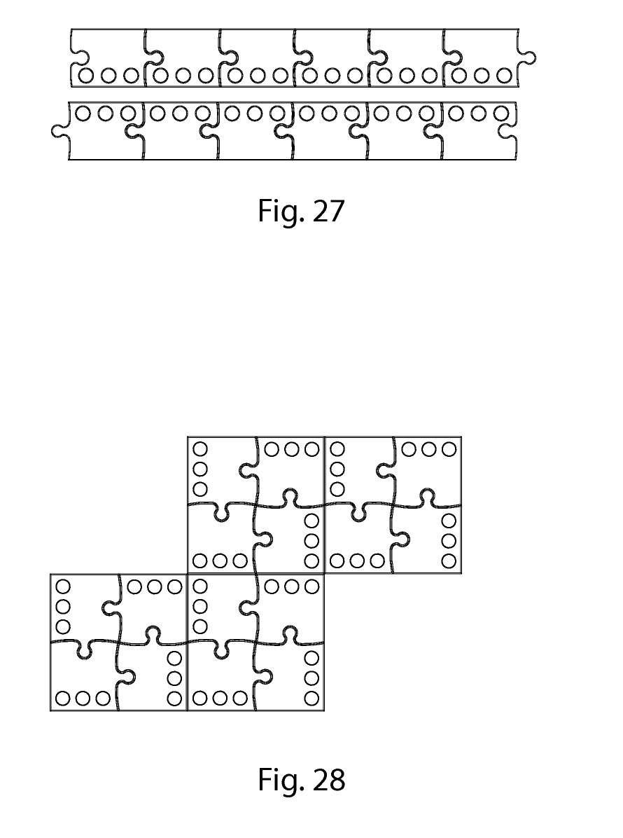

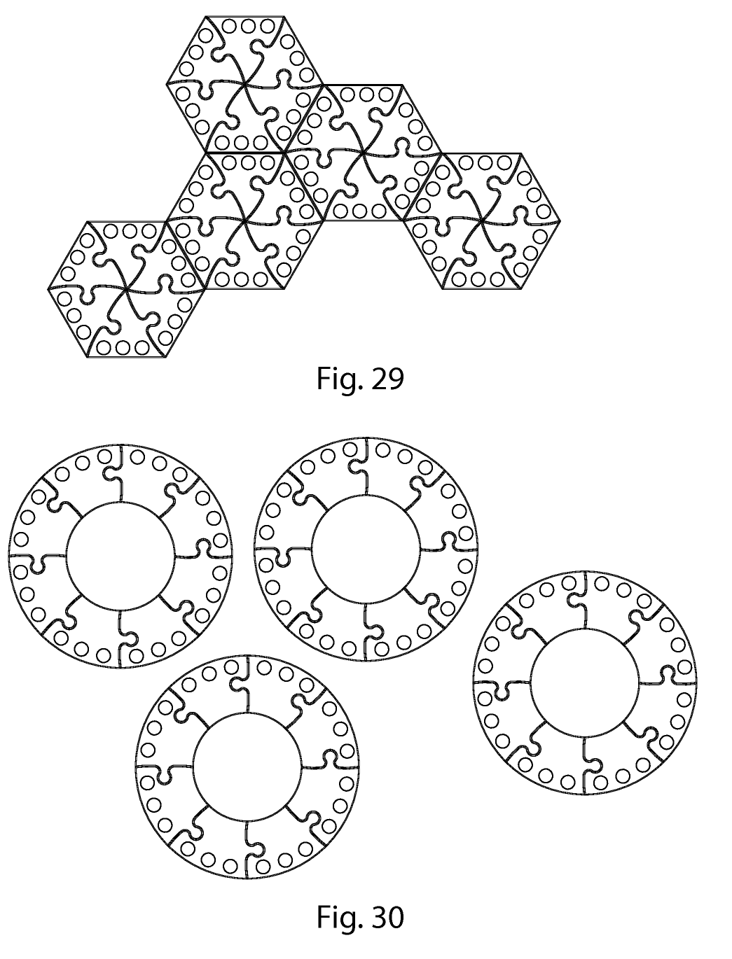

In the version as shown, the board is configured to attach to one another like a jig-saw puzzle. This is accomplished by shaping the board to consist of a blank/holder 16 and a tab/handle 10 (tab and blank are references to jig-saw puzzle terminology). The tab/handle 10 fitting into the blank/holder 16 are illustrated in FIG. 19, 20, 27, 28, 29, 30. Additionally, the blank/holder 16 is configured to be able to hold glasses, including but not limited to, wine glasses. This is accomplished by the shape and the size of the blank/holder 16 and the tab/handle 10. The tab/handle 10 fits comfortably in one's hand and the blank/holder 16 is configured to hold the glass without the glass falling through the holder.

One portion of the cutting/serving board is configured to allow the board and a glass to rest simultaneously on a countertop surface with the glass in the holder FIG. 4, 5, 7, 12. In the version as shown, this is accomplished by providing an indent into the bottom surface of the board 18. The indentation 18 in the bottom surface of the board at the blank/holder 16 area provide adequate space for the base of the glass to rest on a countertop without impeding on the ability of the board to rest flatly on the countertop.

The aggregate connecting cutting/serving board includes three cavities 12 on the upper surface 16. In the version as shown, this is accomplished by providing an indent into the upper surface 16 of the board.

In use, the aggregate connecting cutting/serving board may be placed on a countertop FIG. 4,7,12,20, or held in one's hand FIG. 1,6,11,21,23,25. A preferred version of the invention includes a cutting board that is configured for use in cutting food items, and a serving board that is configured for use in serving food items. The invention may be configured to connect to one another to create a larger cutting/serving surface FIG. 19,20,27,28,29,30. When the invention is held in one's hand, the board may be used to hold a glass, including but not limited to, wine glasses FIG. 1,6,11,21,23,25. The cavities 12 on the upper surface may be used to hold condiments or sauces. When placed on a countertop, the invention is able to sit directly on top of the base of the glass FIG. 4,7,12.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A food preparation and food serving device, comprising: a cutting/serving board having an upper surface and a lower surface, the upper surface being planar, the lower surface being planar, the cutting/serving board further having a first and a second end, the first end and the second end being formed such that the two ends join end to end.

2. The food preparation and food serving device of claim 1, wherein the upper surface being planar with cavities, the lower surface being planar with an indentation.

3. The food preparation and food serving device of claim 2, wherein the cutting/serving board have a tab/handle end and a blank/holder end, the tab/handle end and the blank/holder being formed such that the two ends join end to end.

4. The food preparation and food serving device of claim 3, wherein the cutting/serving board has any three-dimensional geometric shape.

5. The food preparation and food serving device of claim 4, wherein the cutting/serving board has a rectangular shape, a triangular shape, a square shape, or a curved shape.
